(19) United States
(12) Patent Application Publication
(10) Pub. No.: US 2022/0342882 A1
(43) Pub. Date: Oct. 27, 2022

(54) Method and Apparatus for Asset Management

(71) Applicant: Siemens Aktiengesellschaft, München (DE)

(72) Inventors: Dai Fei Guo, Beijing, Hia Dian District (CN); Li Juan Zhao, Beijing (CN)

(73) Assignee: Siemens Aktiengesellschaft, München (DE)

(21) Appl. No.: 17/640,320

(22) PCT Filed: Sep. 3, 2019
(86) PCT No.: PCT/CN2019/104246

§ 371 Date: Mar. 3, 2022

(51) Int. Cl. G06F 16/2458; G06F 16/215

(52) U.S. Cl. CPC G06F 16/2468; G06F 16/215

(57) ABSTRACT

Various embodiments of the teachings herein include a method for asset management. The method includes: acquiring an asset management request including a list of asset information of assets to be managed; searching the acquired asset information in an asset information database; performing rule matching based on a rule library using the asset information, if the acquired asset information is not found in the asset information database; performing fuzzy matching using the asset information, if the rule matching is unsuccessful; and inserting assets obtained in the fuzzy matching into an asset database, if the fuzzy matching is successful.

### CROSS-REFERENCE TO RELATED APPLICATIONS

This application is a U.S. National Stage Application of International Application No. PCT/CN2019/104246 filed Sep. 3, 2019, which designates the United States of America. The contents of which is hereby incorporated by reference in their entirety.

### TECHNICAL FIELD

The disclosure relates to asset management field. Various embodiments of the teachings herein may include method and/or apparatuses for asset management.

### BACKGROUND

An organization's infrastructure consists of many assets, such as firewalls, switches, routers, hypervisors and application servers etc. A single vulnerability in any of them may potentially compromise the whole infrastructure, and thus it is crucial to maintain an overview of the assets and relevant security status of the assets such as existing security vulnerability.

The number of information system provides implementing asset management approach is growing fast. Although the asset management approach can offer automated collection of asset information, unfortunately the consequence of asset collection is not accurate because of different system responses, even worse, an asset management approach may cause potential system crash in case of inappropriate action. If the existing assets cannot be identified and the asset information cannot be collected, the owner cannot manage these assets in right time and right approach, which may impact the whole infrastructure. In addition, if the asset information is incorrectly collected, for instance, a wrong version for a software product, which is not existed, was collected via asset management system. It may take the owner a lot of maintenance or management time for the nonexistent asset. However, it indeed does not make sense.

Furthermore, when the asset that the customer provides does not exist, the system just takes reject action directly. However, there are two disadvantages for this disposition. Firstly, it may be a misinput that causes the error asset information. If the system can correct the misinput during disposition, it will enhance the efficiency of asset management. Secondly, the customer may resubmit the request, which wastes time and does not make sense.

### SUMMARY

In view of the foregoing, the present application provides a method and apparatus for asset management. With the method and apparatus, not only the assets may be identified correctly, but also the similar asset information in regards to the assets that not be found automatically based on the rule may be recommend, and thus the efficiency of the assets management may be enhanced. As an example, some embodiments of the teachings herein include a method (100) for asset management, comprising: acquiring (110) an asset management request, the asset management request includes a list of asset information of assets to be managed; searching (120) the acquired asset information in an asset information database; performing (130) rule matching based on a rule library using the asset information, in case that the acquired asset information is not found in the asset information database; performing (140) fuzzy matching using the asset information, in case that the rule matching is unsuccessful; and inserting (150) assets obtained in the fuzzy matching into an asset database, in case that the fuzzy matching is successful.

In some embodiments, the rules in the rule library are scope-based rules.

In some embodiments, the asset information at least includes asset version, and the rule in the rule library is an asset version that is mapped to a version scope.

In some embodiments, the fuzzy matching includes a forward matching and a backward matching, and performing (150) fuzzy matching using the asset information in case that the rule matching is unsuccessful comprises: performing the forward matching and the backward matching in an order using the asset information, in case that the rule matching is unsuccessful, wherein the latterly performed fuzzy matching is executed only when the previously performed fuzzy matching is unsuccessful.

In some embodiments, the method further comprises: counting (154, 157) the number of historical successes of the forward matching and the backward matching, wherein the order of performing the forward matching and the backward matching is determined based on the number of historical success of the forward matching and the backward matching.

In some embodiments, the order of performing the forward matching and the backward matching is determined based on user's acceptance during last fuzzy matching.

In some embodiments, the order of performing the forward matching and the backward matching is determined based on asset type of the asset.

In some embodiments, the method further comprises updating (160) the rule library based on asset information of assets obtained in the fuzzy matching and the asset information of the assets to be managed, in case that the fuzzy matching is successful.

As another example, some embodiments include an apparatus (500) for asset management, comprising: a request acquiring unit (510) to acquire an asset management request, the asset management request includes a list of asset information of assets to be managed; an information searching unit (520) to search the acquired asset information in an asset information database; a rule matching unit (530) to perform rule matching based on a rule library using the asset information, in case that the acquired asset information is not found in the asset information database; a fuzzy matching unit (540) to perform fuzzy matching using the asset information, in case that the rule matching is unsuccessful; and an inserting unit (550) to insert assets obtained through the fuzzy matching into an asset database, in case that the fuzzy matching is successful.

In some embodiments, the rules in the rule library are scope-based rules.

In some embodiments, the asset information at least includes asset version, and the rule in the rule library is an asset version that is mapped to a version scope.

In some embodiments, the fuzzy matching includes a forward matching and a backward matching, and the fuzzy matching unit (540) is further to: perform the forward matching and the backward matching in an order using the asset information, in case that the rule matching is unsuccessful, wherein the latterly performed fuzzy matching is executed only when the previously performed fuzzy matching is unsuccessful.

In some embodiments, the apparatus further comprises: a counting unit (560) to count the number of historical successes of the forward matching and the backward matching; and an order determining unit (570) to determine an order of performing the forward matching and the backward matching based on the number of historical success of the forward matching and the backward matching.

In some embodiments, the apparatus further comprises an updating unit (580) to update the rule library based on asset information of the assets obtained in the fuzzy matching and the asset information of the assets to be managed, in case that the fuzzy matching is successful.

As another example, some embodiments include a computer device (600) comprising: one or more processors (610); and a memory (620) coupled to the one or more processors (610), for storing computer-executable instructions that, when executed, cause the one or more processors (610) to perform one or more of the methods described herein.

As another example, some embodiments include a machine-readable medium having machine-executable instructions to cause a machine to perform one or more of the methods described herein.

As another example, some embodiment include a computer program product tangibly stored on a computer readable medium and comprising computer executable instructions that, when executed, cause at least one processor to perform one or more of the methods as described herein.

### BRIEF DESCRIPTION OF THE DRAWINGS

Various aspects, features, and advantages of the subject matter will be more apparent from the detailed description set forth below when taken in conjunction with the drawings, in which use of the same reference number in different figures indicates similar or identical items.

FIG. 1 illustrates a flowchart of a method for asset management incorporating teachings of the present disclosure;

FIG. 2 illustrates a flowchart of an example process for rule matching incorporating teachings of the present disclosure;

FIG. 3 illustrates an example of rules in the rule library incorporating teachings of the present disclosure;

FIG. 4 illustrates a flowchart of an example process for fuzzy matching incorporating teachings of the present disclosure;

FIG. 5 illustrates a block diagram of an apparatus for asset management incorporating teachings of the present disclosure; and

FIG. 6 illustrates a block diagram of a computer device for asset management incorporating teachings of the present disclosure.

### DETAILED DESCRIPTION

The teachings of the present disclosure may be incorporated in a method for asset management comprising: acquiring an asset management request, the asset management request includes a list of asset information of assets to be managed; searching the acquired asset information in an asset information database; performing rule matching based on a rule library using the asset information, in case that the acquired asset information is not found in the asset information database; performing fuzzy matching using the asset information, in case that the rule matching is unsuccessful; and inserting assets obtained in the fuzzy matching into an asset database, in case that the fuzzy matching is successful. With this approach, not only the assets may be identified correctly, but also the similar asset information in regards to the assets that not be found automatically based on the rule may be recommend, and thus the efficiency of the assets management may be enhanced.

In some embodiments, the rules in the rule library are scope-based rules. With this approach, the rule matching may be carried out by verifying whether the asset information of the asset to be managed is in a scope specified in a rule, and thus the rule matching may be more accurate.

In some embodiments, the asset information at least includes asset version, and the rule in the rule library is an asset version that is mapped to a version scope. With this approach, the rule matching may be carried out by verifying whether the asset version of the asset to be managed is in a scope specified in a rule, and thus the rule matching may be more accurate.

In some embodiments, the fuzzy matching includes a forward matching and a backward matching, performing fuzzy matching using the asset information in case that the rule matching is unsuccessful comprises: performing the forward matching and the backward matching in an order using the asset information, in case that the rule matching is unsuccessful, wherein the latterly performed fuzzy matching is executed only when the previously performed fuzzy matching is unsuccessful. With this approach, the fuzzy matching may be carried out with the combination of the forward matching and the backward matching, and the latterly performed fuzzy matching is executed only when the previously performed fuzzy matching is unsuccessful. In such way, only one of the forward matching and the backward matching may be performed in some case, and thus the efficiency of the fuzzy matching may be enhanced.

In some embodiments, the method further comprises: counting the number of historical successes of the forward matching and the backward matching, wherein the order of performing the forward matching and the backward matching is determined based on the number of historical success of the forward matching and the backward matching. With this approach, the execution order of the forward matching and the backward matching may be determined based on the number of historical success of the forward matching and the backward matching. In such a way, the firstly performed fuzzy matching may be easier to be accepted by a user, and thus the fuzzy matching process may be ended quickly.

In some embodiments, the order of performing the forward matching and the backward matching is determined based on user's acceptance during last fuzzy matching. Alternatively, the order of performing the forward matching and the backward matching is determined based on asset type of the asset.

In some embodiments, the method further comprises: updating the rule library based on asset information of assets obtained in the fuzzy matching and the asset information of the assets to be managed, in case that the fuzzy matching is successful. With this approach, the rule library may be updated based on the result of the fuzzy matching, and thus the rule library may be reliably expanded.

In some embodiments, an apparatus for asset management comprises: a request acquiring unit to acquire an asset management request, the asset management request includes a list of asset information of assets to be managed; an information searching unit to search the acquired asset information in an asset information database; a rule matching unit to perform rule matching based on a rule library using the asset information, in case that the acquired asset information is not found in the asset information database; a fuzzy matching unit to perform fuzzy matching using the asset information, in case that the rule matching is unsuccessful; and an inserting unit to insert assets obtained in the fuzzy matching into an asset database, in case that the fuzzy matching is successful.

In some embodiments, the rules in the rule library are scope-based rules.

In some embodiments, the asset information at least includes asset version, and the rule in the rule library is an asset version that is mapped to a version scope.

In some embodiments, the fuzzy matching includes a forward matching and a backward matching, and the fuzzy matching unit is further to: perform the forward matching and the backward matching in an order using the asset information, in case that the rule matching is unsuccessful, wherein the latterly performed fuzzy matching is executed only when the previously performed fuzzy matching is unsuccessful.

In some embodiments, the apparatus further comprises: a counting unit to count the number of historical successes of the forward matching and the backward matching; and an order determining unit to determine an order of performing the forward matching and the backward matching based on the number of historical success of the forward matching and the backward matching.

In some embodiments, the apparatus further comprises: an updating unit to update the rule library based on asset information of assets obtained in the fuzzy matching and the asset information of the assets to be managed, in case that the fuzzy matching is successful.

In some embodiments, a computer device for asset management comprises: one or more processors; and a memory coupled to the one or more processors, for storing computer-executable instructions that, when executed, cause the one or more processors to perform the method for asset management as described herein.

In some embodiments, a machine-readable medium for asset management has computer-executable instructions to cause a machine to perform the method for asset management as above.

In some embodiments, a computer program product tangibly stored on a computer readable medium comprises computer executable instructions that, when executed, cause at least one processor to perform the method for asset management as above.

The subject matter described herein will now be discussed with reference to example embodiments. It should be understood that these embodiments are discussed only for the purpose of enabling those skilled persons in the art to better understand and thus implement the subject matter described herein, rather than suggesting a limitation on the scope of protection, applicability, or examples set forth in the claims. Changes may be made in the function and arrangement of the elements discussed without departing from the scope of the disclosure. Each embodiment may omit, substitute, or add various procedures or components as needed. For example, the methods described may be performed in a different order than described, and various steps may be added, omitted, or combined. In addition, features described with respect to some embodiments may also be combined in other embodiments.

As used herein, term “comprise/include” and its variants refer to open terms that mean “comprises/includes, but is not limited to”. The term “based on” refers to “based at least in part on”. The terms “one embodiment” and “an embodiment” refer to “at least one implementation”. The term “another embodiment” refers to “at least one other embodiment”. The term “a” or “an” is to be read as “at least one”. The terms “first”, “second”, and the like may refer to different or same objects. Other definitions, explicit and implicit, may be included below. A definition of a term is consistent throughout the description unless the context clearly indicates otherwise.

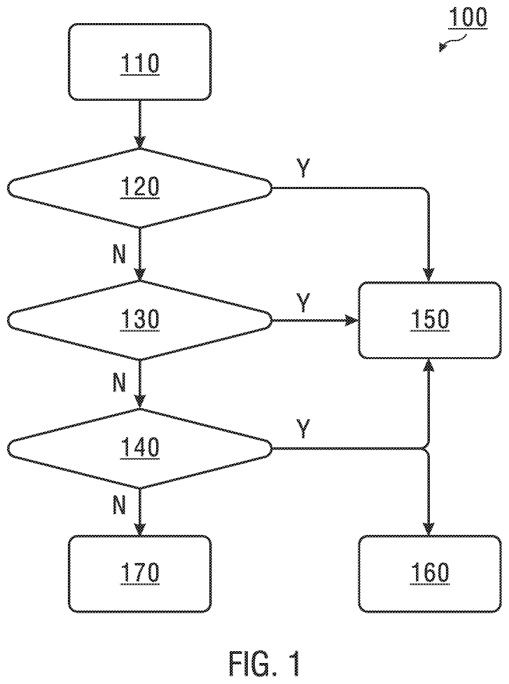

FIG. 1 illustrates a flowchart of a method for asset management (asset management process 100) incorporating teachings of the present disclosure. In this embodiment, the asset management process 100 is performed by an asset management apparatus.

As shown in FIG. 1, in block 110, an asset management request from a user is acquired, and the asset management request includes a list of asset information of assets to be managed. Here, the user may be a person or an entity, such as an enterprise entity, and the asset information is information describing the asset. In an example of the embodiment, the asset information may include at least an asset version of the asset to be managed. In another example of the embodiment, the asset information may include asset's vendor, asset's name, and URL information etc. In addition, the list of asset information is usually provided by the user.

After the acquisition of the asset management request, in block 120, a searching process for the acquired asset information is performed in an asset information database 60. The asset information database 60 is prepared in advance, and the asset information database 60 may be in the asset management apparatus or outside of the asset management apparatus.

When the asset information includes more than one kind of asset information, the asset information may be considered in the asset information database 60 only when all kinds of asset information are same as those of one asset information in the asset information database 60.

If the asset information is found in the asset information database 60, in block 150, the asset to be managed is inserted into an asset database 80. The asset database 80 is for storing the assets for management.

If the asset information is not found in the asset information database 60, in block 130, a rule matching based on a rule library is performed using the asset information. In an example of the embodiments, each of the rules in the rule library is a scope-based rule.

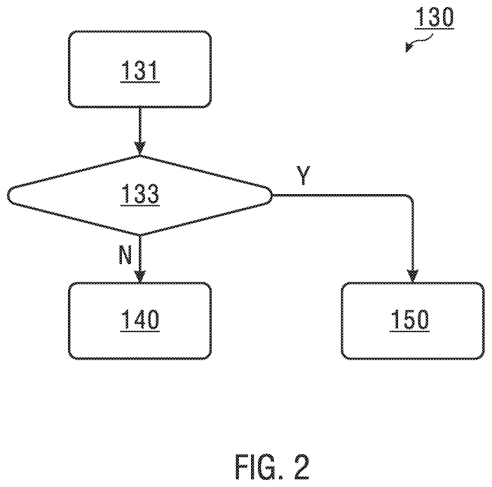

FIG. 2 illustrates a flowchart of an example process for rule matching incorporating teachings of the present disclosure. In this example, asset version is taken as an example of the asset information. In the disclosure, asset version is usually represented with an asset version number, and the asset version number is generally a character string of the number, such as a character string of “3.7.2.5”.

As shown in FIG. 2, in case that the asset information is not found in the asset information database 60, in block 141, the asset version is converted into a numeric value. That is, a character string of “3.7.2.5” is converted into a numeric value of “3.7.2.5”.

Then, in block 143, it is verified whether the converted numeric value is within the range of valued specified by a rule in the rule library 70. In this case, each rule in the rule library 70 is an asset version that is mapped to a version scope.

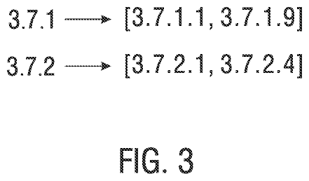

FIG. 3 illustrates an example of rules in the rule library 70 incorporating teachings of the present disclosure. As shown in FIG. 3, rule “3.7.1” is mapped to a version range [3.7.1.1, 3.7.1.9], i.e., a version range from 3.7.1.1 to 3.7.1.9, and rule “3.7.2” is mapped to a version range [3.7.2.1, 3.7.2.4], i.e., a version range from 3.7.2.1 to 3.7.2.4.

If the converted numeric value is within the version range specified by a rule in the rule library 70, the rule matching is successful. And then the process goes to block 150, and in block 150, the asset to be managed is inserted into the asset database 80.

If the converted numeric value is not within the version range specified by rules in the rule library 70, in block 140, a fuzzy matching is performed using the asset version. In an example of the disclosure, the fuzzy matching includes a forward matching and a backward matching. In the forward matching, the oldest one of posterior asset versions compared to the requested version (the asset version of the asset to be managed) is recommended to perform the matching process. In the backward matching, the newest one of previous asset versions compared to the requested version (the asset version of the asset to be managed) is recommended to perform the matching process.

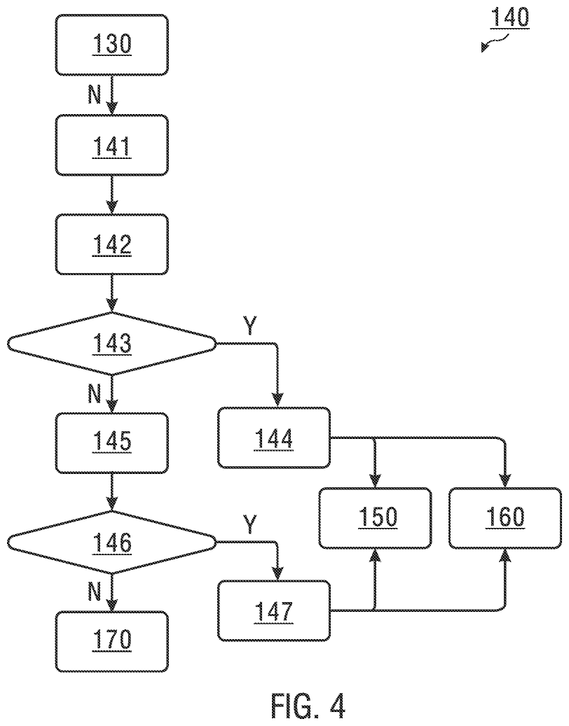

FIG. 4 illustrates a flowchart of an example process for fuzzy matching incorporating teachings of the present disclosure. As shown in FIG. 4, if the converted numeric value is not within the version range specified by rules in the rule library 70, in block 141, the order of performing the forward matching and the backward matching is determined based on the number of historical success of the forward matching and the backward matching. Here, the number of historical success of the forward matching and the backward matching is counted based on the historical result of the forward matching and the backward matching. If the forward matching is successful, the number of historical success of the forward matching is added 1, and if the forward matching is unsuccessful, the number of historical success of the forward matching remains unchanged. If the backward matching is successful, the number of historical success of the backward matching is added 1, and if the backward matching is unsuccessful, the number of historical success of the backward matching remains unchanged. Further, the number of historical success is usually counted for a prescribed period, e.g., a month.

After the order of performing the forward matching and the backward matching is determined, the forward matching and the backward matching are performed in the determined order. As shown in FIG. 4, the order of performing the forward matching and the backward matching is that the forward matching is firstly performed and then the backward matching is performed.

In special, in block 142, a forward matching rule is recommended. Here, the recommended forward matching rule is the newest one of previous asset versions compared to the asset version of the asset to be managed. For example, if the asset version of the asset to be managed is 3.7.3.5, and the oldest one of posterior asset versions compared to 3.7.3.5 is 3.7.3.9 (if have), the asset version 3.7.3.9 is recommended.

Then in block 143, it is determined whether the asset with the recommended asset version 3.7.3.9 is accepted by the user. If the asset with the recommended asset version 3.7.3.9 is accepted by the user, the forward matching is successful, and the process proceeds to block 150. In block 150, an asset with a corresponding asset version is inserted into the asset database 80, e.g., an asset with an asset version 3.7.3.9 is inserted into the asset database 80.

Further, if the forward matching is successful, the process may also proceed to block 144. In block 144, the number of success of forward matching is added 1, and then the process proceeds to block 160. If the asset with the recommended asset version 3.7.3.9 is not accepted by the user, the forward matching is unsuccessful and the process proceeds to block 145.

In block 145, a backward matching rule is recommended. Here, the recommended backward matching rule is the oldest one of posterior asset versions compared to the asset version of the asset to be managed. For example, if the asset version of the asset to be managed is 3.7.3.5, and the newest one of previous asset versions compared to 3.7.3.5 is 3.7.3, the asset version 3.7.3 is recommended.

Then in block 146, it is determined whether the asset with the recommended asset version 3.7.3 is accepted by the user. If the asset with the recommended asset version 3.7.3 is accepted by the user, the backward matching is successful and the process proceeds to block 150. In block 150, an asset with a corresponding asset version is inserted into an asset database, e.g., an asset with a corresponding asset version 3.7.3 is inserted into an asset database.

Further, if the backward matching is successful, the process may also proceed to block 147. In block 147, the number of success of backward matching is added 1, and then the process proceeds to block 160.

In block 160, the rule library is updated based on the asset version of the asset obtained in the fuzzy matching (i.e., the asset accepted by the user) and the asset version of the asset to be managed. For example, if the backward matching is successful, e.g., the asset with the recommended asset version 3.7.3 is accepted by the user, a rule 3.7.3, which is mapped to a value range from 3.7.3.1 to 3.7.3.5, is added into the rule library 70. If the forward matching is successful, e.g., the asset with the recommended asset version 3.7.3.9 is accepted by the user, a rule 3.7.3.9, which is mapped to a value range from 3.7.3.5 to 3.7.3.9, is added into the rule library 70.

If the fuzzy matching is unsuccessful, in block 170, the asset to be managed is rejected. That is, the asset is not inserted into asset database 80. Further, it should be noted that, in another example of the embodiments, the order of performing the forward matching and the backward matching is determined based on user's acceptance during last fuzzy matching. Alternatively, the order of performing the forward matching and the backward matching is determined based on asset type of the asset. In this example, each asset type has a preferred execution order of fuzzy matching. For example, asset type 1 preferably performs forward matching first, and then performs backward matching. So if the asset type of the asset is asset type 1, the execution order of the fuzzy matching is to perform forward matching first, and then perform backward matching.

It should be noted that, the example shown in FIG. 4 is merely illustrative. In other examples, other kinds of asset information may be also used. In this case, the newest one of previous asset information for the asset version of the asset to be managed may be recommended in the backward matching, and the oldest one of posterior asset information for the asset version of the asset to be managed may be recommended in the forward matching.

Embodiments of a method for asset management according to the present disclosure have been described as above with reference to FIGS. 1 to 4. It should be noted that, the above embodiments are merely illustrative, and in other embodiments of the present disclosure, the method for asset management illustrated in FIGS. 1-4 may also be modified. For example, in other embodiments, the operation of block 160 in the embodiment of FIG. 1 may be omitted, and one of more of the operations in block 141, block 144 and block 147 in the embodiment of FIG. 4 may be omitted. Further, in other embodiments, the operations of block 150 and/or 160 may be performed before the operations in block 144 and/or block 147.

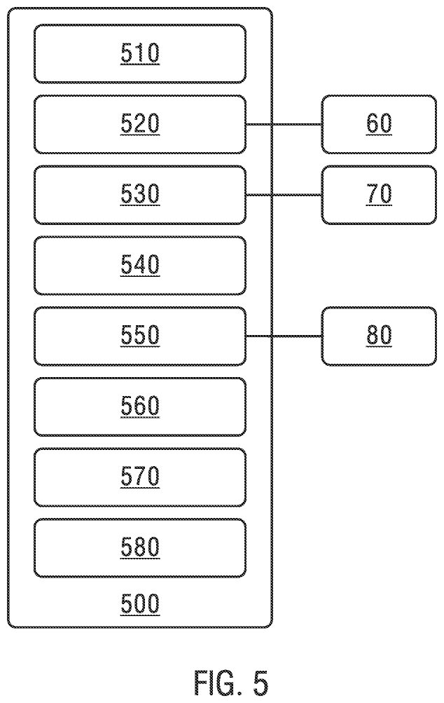

FIG. 5 illustrates a block diagram of an apparatus for asset management (asset management apparatus 500) incorporating teachings of the present disclosure. As shown in FIG. 5, the asset management apparatus 500 includes a request acquiring unit 510, an information searching unit 520, a rule matching unit 530, a fuzzy matching unit 540 and an inserting unit 550.

The request acquiring unit 510 is configured to acquire an asset management request, the asset management request includes a list of asset information of the asset to be managed. The operation of the request acquiring unit 510 may be refer to the operation of block 110 described above with reference to FIG. 1.

The information searching unit 520 is configured to search the acquired asset information in an asset information database. The operation of the information searching unit 520 may be referred to the operation of block 120 described above with reference to FIG. 1.

The rule matching unit 530 is configured to perform rule matching based on a rule library using the asset information, in case that the acquired asset information is not found in the asset information database. The operation of the rule matching unit 530 may be referred to the operation of block 130 described above with reference to FIG. 1 and the operation described above with reference to FIG. 2-3.

The fuzzy matching unit 540 is configured to perform fuzzy matching using the asset information, in case that the rule matching is unsuccessful. The operation of the fuzzy matching unit 540 may be referred to the operation of block 140 described above with reference to FIG. 1 and the operation described above with reference to FIG. 4.

The inserting unit 550 is configured to insert assets obtained in the fuzzy matching into an asset database 80, in case that the fuzzy matching is successful. Further, the inserting unit 550 may be further to insert the asset to be managed into the asset database, in case that the acquired asset information is found in the asset information management library or the rule matching is successful. In addition, the inserting unit 550 may be further to reject the asset to be managed in case that the fuzzy matching is unsuccessful. The operation of the fuzzy matching unit 540 may be referred to the operations of block 150/170 described above with reference to FIG. 1.

Further, in the embodiments of the teachings herein, the fuzzy matching may include a forward matching and a backward matching. Accordingly, the fuzzy matching unit 540 may be further to perform the forward matching and the backward matching in an order using the asset information, in case that the rule matching is unsuccessful, and the latterly performed fuzzy matching is executed only when the previously performed fuzzy matching is unsuccessful. Furthermore, the newest one of previous asset information for the asset version of the asset to be managed is recommended in the forward matching, and the oldest one of posterior asset information for the asset version of the asset to be managed is recommended in the backward matching.

In some embodiments, the asset management apparatus 500 may also include a counting unit 560 and an order determining unit 570.

The counting unit 560 is configured to count the number of historical successes of the forward matching and the backward matching. If the forward matching is successful, the number of historical success of the forward matching is added 1, and if the forward matching is unsuccessful, the number of historical success of the forward matching remains unchanged. If the backward matching is successful, the number of historical success of the backward matching is added 1, and if the backward matching is unsuccessful, the number of historical success of the backward matching remains unchanged. Further, the number of historical success is usually counted for a prescribed period, e.g., a month.

The order determining unit 570 is configured to determine an order of performing the forward matching and the backward matching based on the number of historical success of the forward matching and the backward matching. The operation of the order determining unit 570 may be referred to the operation of block 141 described above with reference to FIG. 4.

In some embodiments, the asset management apparatus 500 may also include an updating unit 580. The updating unit 580 is configured to update the rule library based on asset information of assets obtained in the fuzzy matching and the asset information of the assets to be managed, in case that the fuzzy matching is successful. The operation of the updating unit 580 may be referred to the operation of block 160 described above with reference to FIG. 1 and FIG. 4.

Embodiments of a method and apparatus for asset management according to the present disclosure have been described as above with reference to FIGS. 1 to 5. The above asset management apparatus may be implemented in hardware, software or a combination of hardware and software.

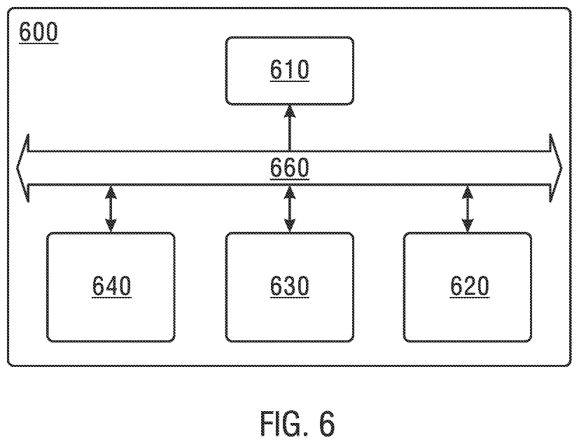

In some embodiments, the asset management apparatus 500 may be implemented using a computing device. FIG. 6 illustrates a block diagram of a computer device 600 for asset management incorporating teachings of the present disclosure. In some embodiments, the computing device 600 may include at least one processor 610, memory 620 (e.g., a non-volatile memory), cache 630, and communication interface 640, and at least one processor 610, memory 620, cache 630, and communication interface 640 are coupled together via a bus 660. At least one processor 610 executes at least one computer readable instruction (i.e., an element implemented in software as described above) stored or encoded in memory 620.

In some embodiments, the computer-executable instructions stored in the memory, when executed, may cause the one or more processors 610 to: acquiring an asset management request, the asset management request includes a list of asset information of assets to be managed; searching the acquired asset information in an asset information database; performing rule matching based on a rule library using the asset information, in case that the acquired asset information is not found in the asset information database; performing fuzzy matching using the asset information, in case that the rule matching is unsuccessful; and inserting assets obtained in the fuzzy matching into an asset database, in case that the fuzzy matching is successful.

In some embodiments, the computer-executable instructions stored in the memory, when executed, may cause the one or more processors 610 to perform the respective operations or functions as described above with reference to FIGS. 1 to 5 in various embodiments of the subject matter.

In some embodiments, a program product such as a non-transitory machine-readable medium is provided. The machine-readable medium may have instructions (i.e., the above elements implemented in software) thereon which, when executed by a machine, cause the machine to perform the operations or functions as described above with reference to FIGS. 1 to 5 in various embodiments of the subject matter. Specifically, a system or apparatus configured with a readable storage medium may be provided, and a software program code for realizing the functions of any of the above embodiments may be stored on the readable storage medium and may be read out and executed by the machine.

In this case, the program code itself read from the readable storage medium may realize the functions of any of the above embodiments, and thus the machine readable code and the readable storage medium storing the machine readable code form part of the present disclosure.

Examples of the readable storage media may include floppy disks, hard disks, magneto-optical disks, optical disks (such as CD-ROM, CD-R, CD-RW, DVD-ROM, DVD-RAM, DVD-RW, DVD-RW), magnetic tape, non-volatile memory card, and ROM. Alternatively, a program code may be downloaded from a server computer or cloud via a communication network.

It should be noted that not all steps and units in the above-mentioned processes and system architecture diagrams are necessary, and certain steps or units may be omitted as needed. The execution order of each step is not fixed and may be adjusted as needed. The structures of the apparatus described in the foregoing embodiments may be physical structures or logical structures, that is, some units may be implemented by the same physical entity, or some units may be implemented by a plurality of different physical entities, respectively, or may be implemented by some components of a plurality of standalone device together.

In some embodiments, the hardware unit or module may be implemented by mechanical or electrical means. For example, a hardware unit, module, or processor may include a permanently dedicated circuitry or logic (e.g., a specialized processor, FPGA, or ASIC) to perform the corresponding operations. A hardware unit or processor may also include a programmable logic or circuitry (such as a general-purpose processor or other programmable processor) that may be temporarily set by software to perform the corresponding operations. Specific implementations (mechanical, or dedicated, permanent circuits, or temporarily set up circuits) may be determined based on cost and time considerations.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the teachings of the present disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

### NUMERICAL REFERENCES IN THE DRAWINGS

100 an asset management process
110 acquire an asset management request, the asset management request includes a list of asset information of assets to be managed
120 asset information search?
130 rule matching?
140 fuzzy matching?
131 convert asset version into numeric
133 within a version range corresponding to the rule?
150 asset insertion
141 determine an order of performing the forward matching and the
backward matching
142 forward matching rule recommendation
143 user's acceptance?
144 the number of success of forward matching plus 1
145 backward matching rule recommendation
146 user's acceptance?
147 the number of success of backward matching plus 1
160 rule library adjustment
170 asset rejection
500 asset management apparatus
510 request acquiring unit
520 information searching unit
530 rule matching unit
540 fuzzy matching unit
550 inserting unit
560 counting unit
570 order determining unit
580 updating unit
asset information database
rule library
asset database
600 computer device
610 at least one processors
620 memory
630 cache
640 communication interface
660 bus

What is claimed is:

1. A method for asset management, the method comprising:
acquiring an asset management request including a list of asset information of assets to be managed;
searching the acquired asset information in an asset information database;
performing rule matching based on a rule library using the asset information, if the acquired asset information is not found in the asset information database;
performing fuzzy matching using the asset information, if the rule matching is unsuccessful; and
inserting assets obtained in the fuzzy matching into an asset database, if the fuzzy matching is successful.

2. The method of claim 1, wherein the rules in the rule library are scope-based rules.

3. The method of claim 2, wherein
the asset information includes asset version; and
the rule in the rule library is an asset version mapped to a version scope.

4. The method of claim 1, wherein:
the fuzzy matching includes a forward matching and a backward matching; and
performing fuzzy matching using the asset information comprises:
performing the forward matching and the backward matching in an order using the asset information, if the rule matching is unsuccessful,
wherein the latterly performed fuzzy matching is executed only if the previously performed fuzzy matching is unsuccessful.

5. The method of claim 4, further comprising
counting a number of historical successes of the forward matching and the backward matching;
wherein the order of performing the forward matching and the backward matching is determined based on the number of historical success of the forward matching and the backward matching.

6. The method of claim 4, further comprising determining an order of performing the forward matching and the backward matching based on a user's acceptance during last fuzzy matching.

7. The method of claim 4, further comprising determining an order of performing the forward matching and the backward matching based on an asset type of the asset.

8. The method of claim 1, further comprising
updating the rule library based on asset information of assets obtained in the fuzzy matching and the asset information of the assets to be managed, if the fuzzy matching is successful.

9. An apparatus for asset management, the apparatus comprising:
a request acquiring unit to acquire an asset management request including a list of asset information of assets to be managed;
an information searching unit to search the acquired asset information in an asset information database;
a rule matching unit to perform rule matching based on a rule library using the asset information, if the acquired asset information is not found in the asset information database;
a fuzzy matching unit to perform fuzzy matching using the asset information, if the rule matching is unsuccessful; and
an inserting unit to insert assets obtained through the fuzzy matching into an asset database, if the fuzzy matching is successful.

10. The apparatus of claim 7, wherein the rules in the rule library comprise scope-based rules.

11. The apparatus of claim 7, wherein the asset information includes asset version; and
the rule in the rule library is an asset version that is mapped to a version scope.

12. The apparatus of claim 7, wherein the fuzzy matching includes a forward matching and a backward matching, and
the fuzzy matching unit further:
perform the forward matching and the backward matching in an order using the asset information, if the rule matching is unsuccessful;
wherein the latterly performed fuzzy matching is executed only when the previously performed fuzzy matching is unsuccessful.

13. The apparatus of claim 10, further comprising:
a counting unit to count a number of historical successes of the forward matching and the backward matching; and
an order determining unit to determine an order of performing the forward matching and the backward matching based on the number of historical success of the forward matching and the backward matching.

14. The apparatus of claim 7, further comprising
an updating unit to update the rule library based on asset information of the assets obtained in the fuzzy matching and the asset information of the assets to be managed, if the fuzzy matching is successful.

15. A computer device comprising:
a processor; and
a memory coupled to the processor for storing computer-executable instructions that, when executed, cause the processor to:
acquire an asset management request including a list of asset information of assets to be managed;
search the acquired asset information in an asset information database;
perform rule matching based on a rule library using the asset information, if the acquired asset information is not found in the asset information database;
perform fuzzy matching using the asset information, if the rule matching is unsuccessful; and
insert assets obtained in the fuzzy matching into an asset database, if the fuzzy matching is successful.

16-17. (canceled)
